(19) United States
(12) Patent Application Publication
(10) Pub. No.: US 2025/0074115 A1
(43) Pub. Date: Mar. 6, 2025

(54) VEHICLE, AXLE ASSEMBLY, AND METHOD OF MODULATING A TEMPERATURE OF LUBRICANT IN A VEHICLE AXLE ASSEMBLY

(71) Applicant: DEERE & COMPANY, MOLINE, IL (US)

(72) Inventors: KEVIN M. ALLEN, BARTLESVILLE, OK (US); SHANTANU S. JOSHI, PUNE (IN)

(21) Appl. No.: 18/456,721

(22) Filed: Aug. 28, 2023

(51) Int. Cl. B60B 35/12; B60K 11/02; B60T 5/00; F01P 3/20; F16D 65/853

(52) U.S. Cl. CPC B60B 35/12; B60K 11/02; B60T 5/00; F01P 3/20; F16D 65/853; B60B 2900/513; B60B 2900/561; F01P 2060/045

(57) ABSTRACT

An axle assembly includes an axle configured for rotation by receiving rotational power from the power source and an axle housing containing the axle. The axle assembly further includes a brake disk disposed in the axle housing, coupled to the axle, and configured for rotation upon the rotation of the axle, a lubricant circuit extending from a lubricant circuit inlet axially aligned with the brake disk to a lubricant circuit outlet in the axle housing, and a heat exchanger disposed in the lubricant circuit to exchange heat between lubricant in the lubricant circuit and coolant circulating through the heat exchanger.

### BACKGROUND

A vehicle, such as an on-road or off-road dump truck or other work vehicle, may include one or more axle assemblies at a rear end of the vehicle to transfer motive power from a power source to the wheels or other ground engaging components. The vehicle may include one or more brake assemblies and the axle assembly may utilize lubricant for lubrication of moving parts in the axle assembly. The temperature of the lubricant may increase due to action of the axle assembly and/or work performed by a brake assembly.

### SUMMARY

According to an aspect of the present disclosure, a vehicle having a front end and a rear end includes a power source configured to provide motive power to the vehicle, an axle configured for rotation by receiving rotational power from the power source, an axle housing containing the axle, a brake disk disposed in the axle housing, coupled to the axle, and configured for rotation upon the rotation of the axle, a lubricant circuit extending from a lubricant circuit inlet axially aligned with the brake disk to a lubricant circuit outlet in the axle housing, and a heat exchanger disposed in the lubricant circuit to exchange heat between lubricant in the lubricant circuit and coolant circulating through the heat exchanger.

The vehicle may further include a coolant circuit extending from the power source and through the heat exchanger. The axle housing may be disposed at the rear end of the vehicle and the power source may be located at the front end of the vehicle. The power source may be an internal combustion engine and the coolant circulating through the heat exchanger may be an internal combustion engine coolant configured to cool the internal combustion engine.

According to an aspect of the present disclosure, an axle assembly receiving rotational power from a power source in a vehicle includes an axle configured for rotation, an axle housing containing the axle, a brake disk disposed in the axle housing, coupled to the axle, and configured for rotation upon the rotation of the axle, a lubricant circuit extending from a lubricant circuit inlet axially aligned with the brake disk to a lubricant circuit outlet in the axle housing, and a heat exchanger disposed in the lubricant circuit to exchange heat between lubricant in the lubricant circuit and coolant circulating through the heat exchanger.

The heat exchanger may be mounted to the axle housing. The heat exchanger may include a heat exchanger core that is spaced apart from the axle housing. The lubricant circuit outlet may be axially spaced from the brake disk. The assembly may further include a second brake disk disposed in the axle housing, coupled to the axle, and configured for rotation upon the rotation of the axle, wherein the lubricant circuit may include a lubricant circuit second inlet axially aligned with the second brake disk. The assembly may further include a lubricant circuit second outlet in the axle housing that is axially spaced from the second brake disk. The assembly may further include a coolant circuit extending from the power source and through the heat exchanger. The axle housing may be disposed at a rear end of the vehicle and the power source may be located at a front end of the vehicle opposite from the rear end of the vehicle. The power source may be an internal combustion engine and the coolant circulating through the heat exchanger may be an internal combustion engine coolant configured to cool the internal combustion engine.

According to an aspect of the present disclosure, a method of modulating a temperature of lubricant in an axle assembly having an axle housing containing an axle of a vehicle having a power source providing rotational power to the axle includes sending the lubricant in a radially outward direction in the axle housing to a lubrication circuit inlet using rotation of a brake disk that is coupled to the axle and configured for rotation upon the rotation of the axle, circulating the lubricant from a lubrication circuit inlet to a lubricant circuit outlet in the axle housing, and circulating the lubricant through a heat exchanger disposed in the lubrication circuit to modulate the temperature of the lubricant by exchanging heat between the lubricant and a coolant in the heat exchanger.

The method may include circulating the lubricant from the brake disk in the axle housing to the heat exchanger disposed outside of the axle housing. The method may include facilitating airflow around a heat exchanger core of the heat exchanger by spacing the heat exchanger core apart from the axle housing. The method may include circulating the coolant from the power source and through the heat exchanger. The method may include cooling the power source with the coolant and cooling the lubricant with the coolant using the heat exchanger. The method may include cooling the lubricant with the coolant using the heat exchanger when a lubricant temperature is higher than a coolant temperature. The method may further include heating the lubricant with the coolant using the heat exchanger upon an initial rotation of the axle.

Other features and aspects will become apparent by consideration of the detailed description, claims, and accompanying drawings.

### BRIEF DESCRIPTION OF THE DRAWINGS

The detailed description of the drawings refers to the accompanying figures.

FIG. 1 illustrates a vehicle in accordance with an embodiment of the present disclosure.

FIG. 2 illustrates an axle assembly in accordance with an embodiment of the present disclosure.

FIG. 3 illustrates an axle assembly in accordance with an embodiment of the present disclosure.

FIG. 4 illustrates an axle assembly in accordance with an embodiment of the present disclosure.

FIG. 5. illustrates an axle assembly in accordance with an embodiment of the present disclosure.

FIG. 6 illustrates a method of modulating a temperature of lubricant in accordance with an embodiment of the present disclosure.

Like reference numerals are used to indicate like elements throughout the several figures.

### DETAILED DESCRIPTION

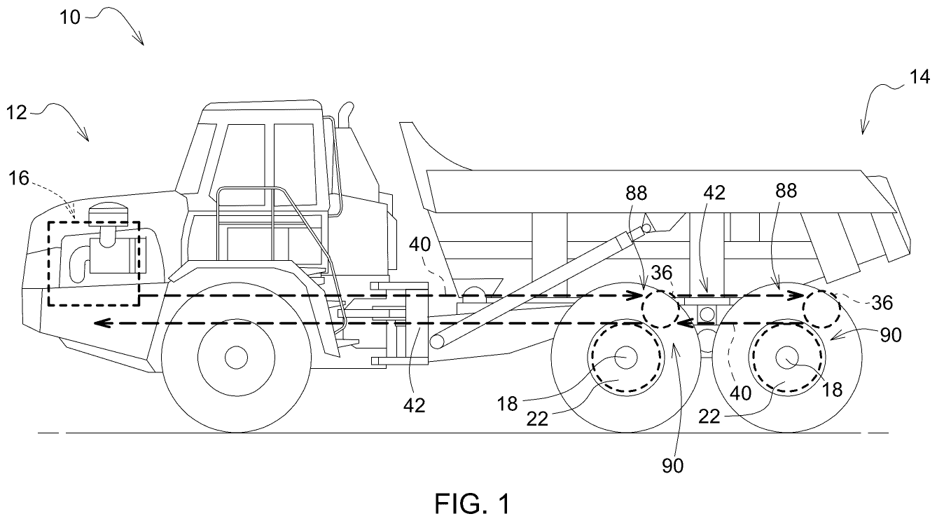

Referring to FIG. 1, a vehicle 10 is provided having a front end 12 and a rear end 14 located at an opposite end of the vehicle 10 from the front end 12. The vehicle 10 includes a power source 16, such as a diesel or gasoline internal combustion engine, electric or hydraulic motor or machine, or any combination thereof, in non-limiting examples, that is configured to provide motive power to the vehicle 10.

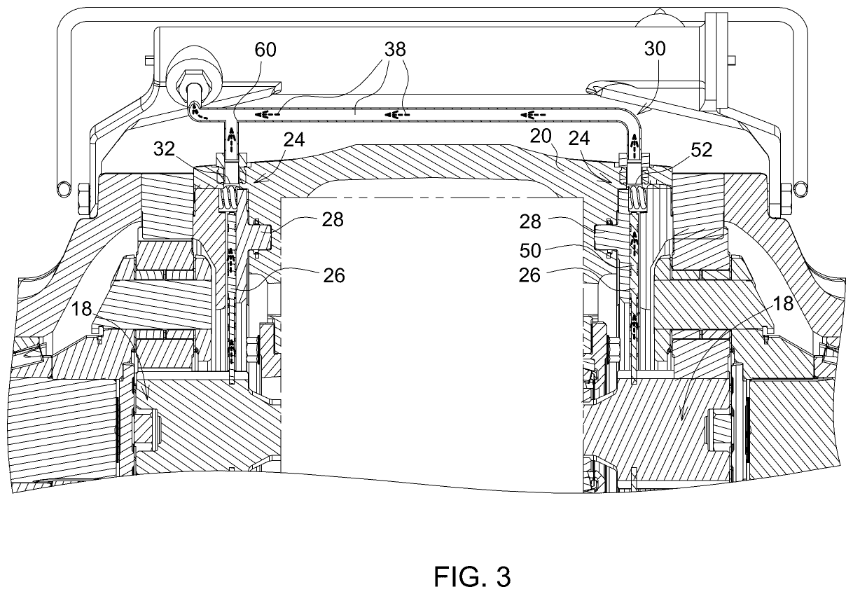

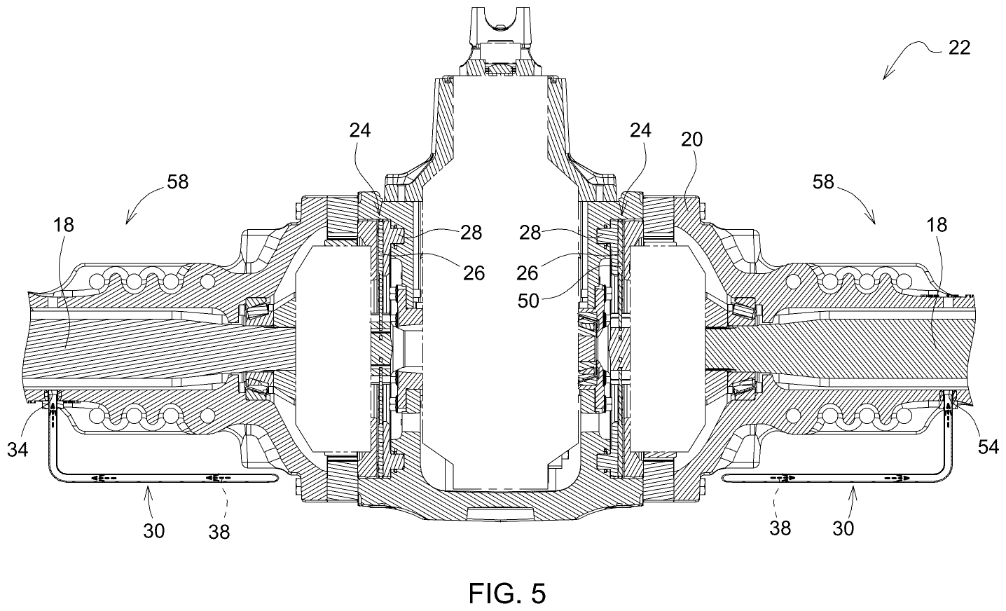

As shown in further detail in FIGS. 3 and 5, the vehicle 10 further includes at least one axle assembly 22 having an axle 18 configured for rotation by receiving rotational power from the power source 16. The vehicle 10 in the embodiment illustrated in FIG. 1 includes two axle assemblies 22 located at the rear end 14 of the vehicle 10, but the vehicle 10 may include any number of axle assemblies 22 located at the front end 12 and/or the rear end 14 in additional embodiments of the present disclosure. The vehicle 10 and the axle assembly 22 further include an axle housing 20 that contains the axle 18. In the present disclosure, the axle assembly 22 and the axle 18 may be used and referenced interchangeably. The axle housing 20 is disposed at the rear end 14 of the vehicle 10 and the power source 16 is located at the front end 12 of the vehicle 10 in the illustrated embodiment.

The vehicle 10 of FIG. 1 includes one or more drive shafts extending from the power source 16 to the axle assemblies 22 to transfer torque from the power source 16 to the axle(s) 18 in the illustrated embodiment. The vehicle 10 may further include one or more transmissions, gearboxes, or other drivetrain components to transfer power from the power source 16 to the axle assemblies 22.

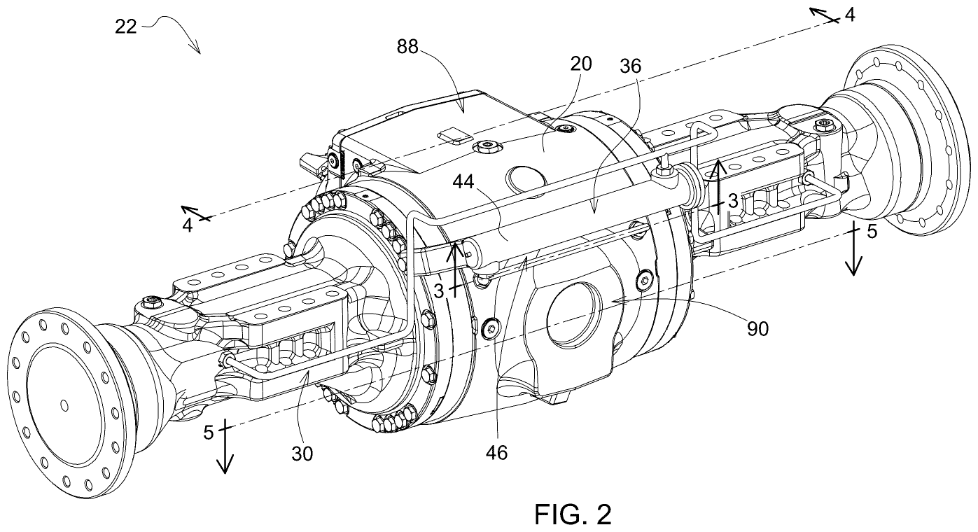

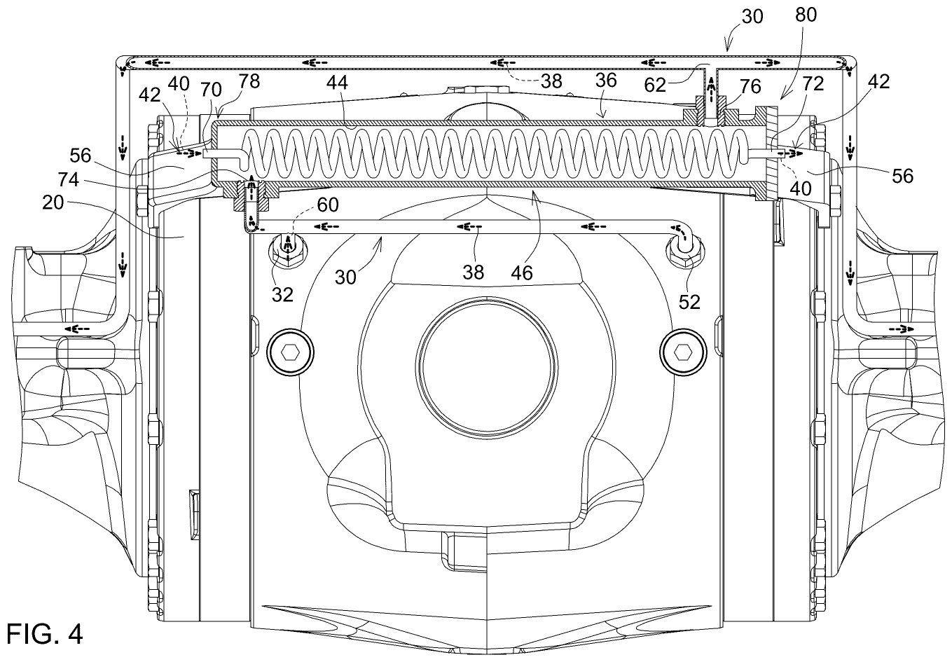

Referring now to FIG. 2 with continuing reference to FIG. 1, the vehicle 10 and the axle assembly 22 include a heat exchanger 36. In the illustrated embodiment of FIG. 2, the heat exchanger 36 is mounted to the axle housing 20. The heat exchanger 36 includes a heat exchanger core 44 that is spaced apart from the axle housing 20 in the illustrated embodiment. As shown in further detail in FIG. 4, an air gap 46 exists between the core 44 and the axle housing 20 in an embodiment to allow airflow across and/or around the core 44. FIG. 1 illustrates that, in an embodiment, the heat exchanger 36 is positioned at an upper end 88 and/or rear end 90 of the axle housing 20.

Referring now to FIG. 3, the vehicle 10 and the axle assembly 22 further include a brake assembly 24. The brake assembly 24 includes a brake disk 26. Although the illustrated embodiment includes a single brake disk 26 on each side of the axle assembly 22, the brake assembly 24 may include a plurality of brake disks 26 and may further include a plurality of separator plates separating adjacent brake disks 26 in additional embodiments not illustrated. The brake disk 26 is disposed in the axle housing 20, coupled to the axle 18, and configured for rotation upon the rotation of the axle 18. The brake assembly 24 further includes a piston 28 configured to move axially to engage the brake disk 26 and resist, slow, or stop movement of the brake disk 26 to enable braking of the vehicle 10.

The vehicle 10 and the axle assembly 22 further include a lubricant circuit 30 extending from a lubricant circuit inlet 32 axially aligned with the brake disk 26, as illustrated in FIGS. 2, 3, and 5, to a lubricant circuit outlet 34 in the axle housing 20, as illustrated in FIGS. 2 and 5. As shown in FIGS. 3 and 4, the lubricant circuit 30 includes two lubricant circuit inlets 32 and a lubricant circuit upstream junction 60 upstream of the heat exchanger 36. The lubricant circuit 30 includes a lubricant inlet 74 at an inlet side 78 of the heat exchanger 36 and a lubricant outlet 76 at an outlet side 80 of the heat exchanger 36. As shown in FIGS. 4 and 5, the lubricant circuit 30 includes two lubricant circuit outlets 34 and a lubricant circuit downstream junction 62 downstream of the heat exchanger 36. In the illustrated embodiment of FIGS. 2 and 5, the lubricant circuit outlet 34 is axially spaced from or disposed axially outside of the brake disk 26.

As illustrated in FIG. 3, a second brake disk 50 is disposed in the axle housing 20, coupled to the axle 18, and configured for rotation upon the rotation of the axle 18. The lubricant circuit 30 includes a lubricant circuit second inlet 52 in an embodiment that is axially aligned with the second brake disk 50. A lubricant circuit second outlet 54 in the axle housing 20 is axially spaced from or disposed axially outside of the second brake disk 50 in the illustrated embodiment. The lubricant circuit outlet 34 and/or the lubricant circuit second outlet 54 of FIG. 5 is/are disposed at one or both outer end(s) 58 of the axle housing 20. In additional embodiments not illustrated, the lubricant circuit outlet 34 and/or the lubricant circuit second outlet 54 is/are located inward of the brake disk 26 and/or the second brake disk 50 and/or at another location of the axle housing 20 or another component of the vehicle 10. The brake disk 26 and/or second brake disk 50 of the illustrated embodiments act to pump the lubricant 38 through the lubricant circuit 30.

Referring to FIG. 4, the heat exchanger 36 is disposed in the lubricant circuit 30 to exchange heat between lubricant 38 in the lubricant circuit 30 and coolant 40 circulating through the heat exchanger 36. As shown in FIGS. 2 and 4, the heat exchanger 36 includes two brackets 56 to mount the heat exchanger 36 to the axle housing 20 and position the heat exchanger core 44 spaced apart from the axle housing 20. The heat exchanger 36 is mounted to the axle housing 20 such that the core 44 is parallel or substantially parallel with the axle 18 and/or perpendicular or substantially perpendicular to a direction of forward travel of the vehicle 10, which may increase the surface area of the core 44 impinged upon by air and improve airflow across or around the heat exchanger 36, thereby improving cooling of both the lubricant 38 and the coolant 40. In additional embodiments, the heat exchanger 36 includes a single bracket 56 or any other number of brackets 56 and/or another structure to mount the heat exchanger 36 to the axle housing 20. In additional embodiments not illustrated, the heat exchanger 36 is integrated into or contained inside the axle assembly 22 and/or the axle housing 20.

With reference to FIGS. 1 and 4, the vehicle 10 and the axle assembly 22 further include a coolant circuit 42 extending from the power source 16 and through the heat exchanger 36. The coolant circuit 42 includes a coolant inlet 70 and a coolant outlet 72 at an outlet side 80 of the heat exchanger 36 that is opposite from the inlet side 78 of the heat exchanger 36. In the illustrated embodiment, the power source 16 is an internal combustion engine and the coolant 40 circulating through the heat exchanger 36 is an internal combustion engine coolant configured to cool the internal combustion engine. The vehicle 10 of an embodiment includes a coolant pump (not shown) configured to pump the coolant 40 between an engine radiator or heat exchanger (not shown) and the internal combustion engine and may be configured to also pump the coolant 40 between the engine heat exchanger and the heat exchanger 36. The axle housing 20 of an embodiment is disposed at the rear end 14 of the vehicle 10 and the power source 16 is located at the front end 12 of the vehicle 10 opposite from the rear end 14 of the vehicle 10. In one or more embodiments not illustrated, one or more of the power source 16, the axle assembly 22, and/or the heat exchanger 36 are located elsewhere on the vehicle 10.

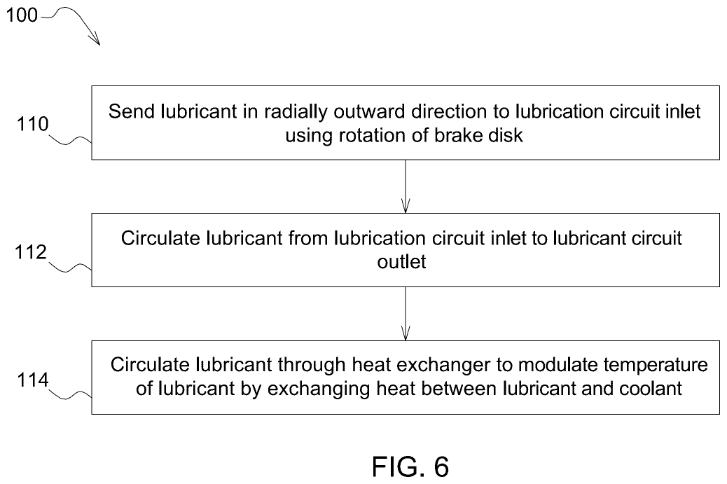

Referring now to FIG. 6, a method 100 includes modulating a temperature of the lubricant 38 in the axle assembly 22 and/or the vehicle 10 is provided. The method 100 includes sending, at step 110, the lubricant 38 in a radially outward direction in the axle housing 20 to the lubrication circuit inlet 32 using rotation of the brake disk 26 that is coupled to the axle 18 and configured for rotation upon the rotation of the axle 18.

The method 100 further includes circulating, at step 112, the lubricant 38 from the lubrication circuit inlet 32 to the lubricant circuit outlet 34 in the axle housing 20. The method 100 further includes circulating, at step 114, the lubricant 38 through the heat exchanger 36 disposed in the lubrication circuit 30 to modulate the temperature of the lubricant 38 by exchanging heat between the lubricant 38 and the coolant 40 in the heat exchanger 36.

In one or more embodiments, the method 100 includes circulating the lubricant 38 from the brake disk 26 in the axle housing 20 to the heat exchanger 36 disposed outside of the axle housing 20. The method 100 may further include facilitating airflow around the heat exchanger core 44 of the heat exchanger 36 by spacing the heat exchanger core 44 apart from the axle housing 20. The method 100 may further include circulating the coolant 40 from the power source 16 and through the heat exchanger 36. The method 100 may further include cooling the power source 16 with the coolant and cooling the lubricant 38 with the coolant 40 using the heat exchanger 36. The method 100 may further include cooling the lubricant 38 with the coolant 40 using the heat exchanger 36 when a lubricant temperature is higher than a coolant temperature.

The method 100 may further include heating the lubricant 38 with the coolant 40 using the heat exchanger 36, such as upon initial rotation of the axle 18. In non-limiting examples, heating the lubricant 38 with the coolant 40 may occur after the vehicle 10 has been immobile and/or the axle 18 has not rotated for a period of time sufficient to reduce the temperature of the lubricant 38. Heating the lubricant 38 with the coolant 40 in such cases is beneficial to increase flow of the relatively viscous, cool lubricant 38 to circulate the lubricant 38 more quickly to parts requiring lubrication and reduce wear, improve durability, and improve efficiency.

Without in any way limiting the scope, interpretation, or application of the claims appearing below, a technical effect of one or more of the example embodiments disclosed herein is cooling or modulating the temperature of the lubricant 38 to reduce degradation of the lubricant 38 and improve the durability and efficiency of the axle assembly 22 and/or the vehicle 10. Another technical effect of one or more of the example embodiments disclosed herein is cooling or heating the lubricant 38 without the need for a separate pump, valving, long lubricant or coolant lines and/or other component to circulate the lubricant 38, which reduces cost and complexity and increases the efficiency and packaging of the axle assembly 22 and the vehicle 10. Further, the lubricant 38 is circulated using and/or flowing directly from the brake disk(s), which is a significant source of heat in the axle assembly 22, toward the heat exchanger 36 to improve heat rejection of the axle assembly 22. Even further, because maximum heat is generated upon braking or decelerating from a relatively high speed of the vehicle 10, and the lubricant-pumping brake disk(s) rotate at relatively high speed during such conditions, improved lubricant cooling occurs when there would be an increased need for cooling of the lubricant 38. Another technical effect of one or more of the example embodiments disclosed herein is to more quickly cool or heat the lubricant 38 such that the lubricant 38 may reach and maintain a desired temperature range for maximum benefit of lubrication and cooling of the components of the axle assembly 22 and the vehicle 10.

As used herein, “e.g.” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A vehicle having a front end and a rear end, the vehicle comprising:
a power source configured to provide motive power to the vehicle;
an axle configured for rotation by receiving rotational power from the power source;
an axle housing containing the axle;
a brake disk disposed in the axle housing, coupled to the axle, and configured for rotation upon the rotation of the axle;
a lubricant circuit extending from a lubricant circuit inlet axially aligned with the brake disk to a lubricant circuit outlet in the axle housing; and
a heat exchanger disposed in the lubricant circuit to exchange heat between lubricant in the lubricant circuit and coolant circulating through the heat exchanger.

2. The vehicle of claim 1, further comprising a coolant circuit extending from the power source and through the heat exchanger.

3. The vehicle of claim 2, wherein the axle housing is disposed at the rear end of the vehicle and the power source is located at the front end of the vehicle.

4. The vehicle of claim 2, wherein the power source is an internal combustion engine and the coolant circulating through the heat exchanger is an internal combustion engine coolant configured to cool the internal combustion engine.

5. An axle assembly receiving rotational power from a power source in a vehicle, the axle assembly comprising:
an axle configured for rotation;
an axle housing containing the axle;
a brake disk disposed in the axle housing, coupled to the axle, and configured for rotation upon the rotation of the axle;
a lubricant circuit extending from a lubricant circuit inlet axially aligned with the brake disk to a lubricant circuit outlet in the axle housing; and
a heat exchanger disposed in the lubricant circuit to exchange heat between lubricant in the lubricant circuit and coolant circulating through the heat exchanger.

6. The assembly of claim 5, wherein the heat exchanger is mounted to the axle housing.

7. The assembly of claim 6, wherein the heat exchanger comprises a heat exchanger core that is spaced apart from the axle housing.

8. The assembly of claim 5, wherein the lubricant circuit outlet is axially spaced from the brake disk.

9. The assembly of claim 5, further comprising a second brake disk disposed in the axle housing, coupled to the axle, and configured for rotation upon the rotation of the axle, wherein the lubricant circuit comprises a lubricant circuit second inlet axially aligned with the second brake disk.

10. The assembly of claim 9, further comprising a lubricant circuit second outlet in the axle housing that is axially spaced from the second brake disk.

11. The assembly of claim 5, further comprising a coolant circuit extending from the power source and through the heat exchanger.

12. The assembly of claim 11, wherein the axle housing is disposed at a rear end of the vehicle and the power source is located at a front end of the vehicle opposite from the rear end of the vehicle.

13. The assembly of claim 11, wherein the power source is an internal combustion engine and the coolant circulating through the heat exchanger is an internal combustion engine coolant configured to cool the internal combustion engine.

14. A method of modulating a temperature of lubricant in an axle assembly having an axle housing containing an axle of a vehicle having a power source providing rotational power to the axle, the method comprising:
sending the lubricant in a radially outward direction in the axle housing to a lubrication circuit inlet using rotation of a brake disk that is coupled to the axle and configured for rotation upon the rotation of the axle;
circulating the lubricant from a lubrication circuit inlet to a lubricant circuit outlet in the axle housing; and
circulating the lubricant through a heat exchanger disposed in the lubrication circuit to modulate the temperature of the lubricant by exchanging heat between the lubricant and a coolant in the heat exchanger.

15. The method of claim 14, further comprising circulating the lubricant from the brake disk in the axle housing to the heat exchanger disposed outside of the axle housing.

16. The method of claim 15, further comprising facilitating airflow around a heat exchanger core of the heat exchanger by spacing the heat exchanger core apart from the axle housing.

17. The method of claim 14, further comprising circulating the coolant from the power source and through the heat exchanger.

18. The method of claim 17, further comprising cooling the power source with the coolant and cooling the lubricant with the coolant using the heat exchanger.

19. The method of claim 14, further comprising cooling the lubricant with the coolant using the heat exchanger when a lubricant temperature is higher than a coolant temperature.

20. The method of claim 14, further comprising heating the lubricant with the coolant using the heat exchanger upon an initial rotation of the axle.
